(19) United States
(12) Patent Application Publication
(10) Pub. No.: US 2008/0289914 A1
(43) Pub. Date: Nov. 27, 2008

(54) Disk Brake, in Particular for a Commercial Vehicle

(75) Inventors: Robert TRIMPE, Wessling (DE); Christian RAFFIN, Grasbrunn (DE); Jose CAMILO-MARTINEZ, Unterhaching (DE)

Correspondence Address: CROWELL & MORING LLP;INTELLECTUAL PROPERTY GROUP, P.O. BOX 14300, WASHINGTON, DC, 20044-4300, US

(73) Assignee: Knorr-Bremse Systeme fuer Nutzfahrzeuge GmbH, Muenchen (DE)

(21) Appl. No.: 12/100,771

(22) Filed: Apr. 10, 2008

Related U.S. Application Data
(63) Continuation of application No. PCT/EP2006/009796, filed on Oct. 11, 2006.

(30) Foreign Application Priority Data
Oct. 13, 2005 (DE) 10 2005 049 057.3

(51) Int. Cl. F16D 65/097

(52) U.S. Cl. 188/73.31

(57) ABSTRACT

A disc brake, particularly for a utility vehicle, includes a caliper that is fastened to a brake support and is provided with a receiving chamber for a clamping mechanism, as well as a brake disc which can be effectively connected to brake pads. The disc brake includes a retaining clip, which is removably fastened to the caliper while supporting springs that act upon the outer edge of the brake pads. One end of the retaining clip positively lies in a receptacle of the caliper while the other end thereof is retained by a fastening element. The fastening element has two limbs, which are secured in holes provided in the caliper on both sides next to the retaining clip.

### BACKGROUND AND SUMMARY OF THE INVENTION

The invention relates to a disk brake, in particular for a commercial or utility vehicle, having a brake caliper that includes a receptacle space for a brake application device, such a caliper engages over a brake disc, which can be operatively connected to brake pads. A retaining clip is detachably fastened to the brake caliper and on which springs that act in an outer edge of the brake pads are supported. The retaining clip bears with one end in a positively locking fashion in a receptacle of the brake caliper, and is retained by its other end via a fastening element.

The retaining clip of such a disk brake, such as is known for example from DE 8615015 U1, serves mainly as a counterbearing for springs, in particular for leaf springs, which stress the brake pads in a spring fashion. In this context, the retaining clip is detachably fastened to the brake caliper so that both rapid mounting and removal of the brake pads is possible. This is in order, for example, to permit easy access to the brake pads, which is necessary for changing the brake lining.

This is also assisted by the fact that the retaining clip can be attached and removed using simple means, for which purpose it is, on the one hand, plugged into a pocket-shaped receptacle of the brake caliper and, on the other hand, permanently connected to the brake caliper via screws while spanning a plug-in opening for the brake pads.

The pocket-shaped receptacle is provided, here, on the side of the brake caliper which forms the outside of the disc brake and which lies opposite a brake application device, which is arranged in the brake caliper and which forms an inner end of the disc brake, that is to say the side facing the center of the vehicle. In this context, the receptacle can be formed by mechanical processing or simply also integrally formed when the brake caliper is manufactured by casting.

As mentioned above, the retaining clip is screwed with its other end, facing the brake application device, to the brake caliper. However, for this purpose, corresponding costly processing is required, i.e. boring of the core bore and subsequent cutting of the thread. Since such disk brakes are manufactured in large numbers, these operations are not compatible with optimized fabrication so that the product can overall only be manufactured at a correspondingly high cost.

It applies equally well to a disk brake in which the pocket-shaped receptacle is provided on the side of the brake caliper which forms the inside of the brake. The retaining clip is secured on the opposite side of the brake, that is to say what is referred to as the outside of the brake, by way of a bolt, a disk and splint, wherein the bolt is connected in a positively engaging fashion to the brake caliper. This positive engagement is manufactured above the retaining clip, which is depressed by the splint in conjunction with the disk and fastened to the bolt.

However, the connection between the bolt/disk and the splint requires corresponding installation space which, owing to the prevailing restricted spatial conditions in the wheel envelope, can be manufactured only at considerable cost.

Furthermore, the processing of a brake-caliper-end bore for receiving the bolt is necessary in a direction other than the main processing direction, which makes the fabrication overall more difficult. The formation of the core bore and the cutting of the thread to manufacture the threaded connection can only be carried out in a direction other than the main processing direction so that the same disadvantages apply here.

The invention is based on the object of developing a disk brake of the above-mentioned type such that it can be manufactured more cost-effectively, and simpler, while making possible faster mounting and removal of the brake pads.

This object is achieved by providing a disk brake having a brake caliper that includes a receptacle space for a brake application device, such a caliper engages over a brake disc, which can be operatively connected to brake pads. A retaining clip is detachably fastened to the brake caliper and on which springs that act on an outer edge of the brake pads are supported. The retaining clip bears with on end in a positively locking fashion in a receptacle of the brake caliper, and is retained by its other end via a fastening element. The fastening element has two limbs, which extend at a distance from one another and which fit in position in a secured fashion in holes provided on both sides next to the retaining clip in the brake caliper.

The invention firstly makes possible, on the one hand, significantly simpler implementation of the structural conditions for securing the fastening element since the required installation space is significantly smaller than the installation space which is required according to the prior art, at least in terms of the height of the installation space which is required.

Particularly given the prevailing restricted spatial conditions, this fact assumes particular importance since the mounting and removal of the fastening element, which are necessary to change the brake pads, are considerably easier.

According to one advantageous development of the invention, there is provision for the holes in which the two limbs of the fastening element, which extend at a distance from one another and preferably parallel to one another, fit to extend in the longitudinal direction of the retaining clip. This permits particularly simple and cost-effective processing of the holes since the processing direction corresponds to the main processing direction so that it does not become necessary to tighten the brake caliper further.

One preferred design of the fastening element is to embody it as a W-shaped, two-limbed, fastening clip whose center region is supported as a bearing limb on the retaining clip, while the two limbs extend at a lower level compared to this bearing limb. The retaining clip is, therefore, secured exclusively by the bearing of the fastening clip, which is formed in such a way that it bears on the retaining clip with a certain degree of pressure.

Particular processing of the retaining clip in the sense of forming holes or receptacles in order to receive the fastening element is no longer necessary by virtue of the invention, which also contributes to optimizing costs. This applies equally well to the fabrication of the brake caliper in a casting method since fewer core parts are now necessary and plug-in cores can basically be dispensed with.

Since it is now possible to dispense with breakthroughs in the retaining clip, that retaining clip can not only be manufactured more easily but it also achieves a higher degree of stiffness. Furthermore, identical retaining clips and fastening elements can be used for differently configured disk brakes, which results in both a reduction in the warehousing costs and in the manufacturing costs themselves.

The aforesaid restoring forces, which are inherent in the fastening clip, by which the fastening clip bears under pressure on the retaining clip, mean that play between the brake pads and the retaining clip is reduced so that the sensitivity to shaking stresses is minimized.

The bearing point of the fastening clip, that is to say of the bearing limb, is preferably located on the retaining clip in a plane with two bases which have the holes for receiving the limbs. This avoids the generation of a bending torque, which would additionally stress the bases. It is therefore possible to manufacture the bases with a small expenditure of material.

Further advantageous embodiments of the invention are described and claimed herein.

### BRIEF DESCRIPTION OF THE DRAWINGS

Exemplary embodiments of the invention will be described below with reference to the appended drawings.

FIG. 1 shows a detail of a disk brake according to the invention in a front view;

FIG. 2 shows a detail of a disk brake in a plan view;

FIGS. 3 and 4 each show a detail of the disk brake in a perspective view;

FIG. 5 shows a detail of the disk brake, likewise in a perspective illustration, and

FIGS. 6 and 7 show further exemplary embodiments of a detail of the disk brake in perspective views.

### DETAILED DESCRIPTION OF THE DRAWINGS

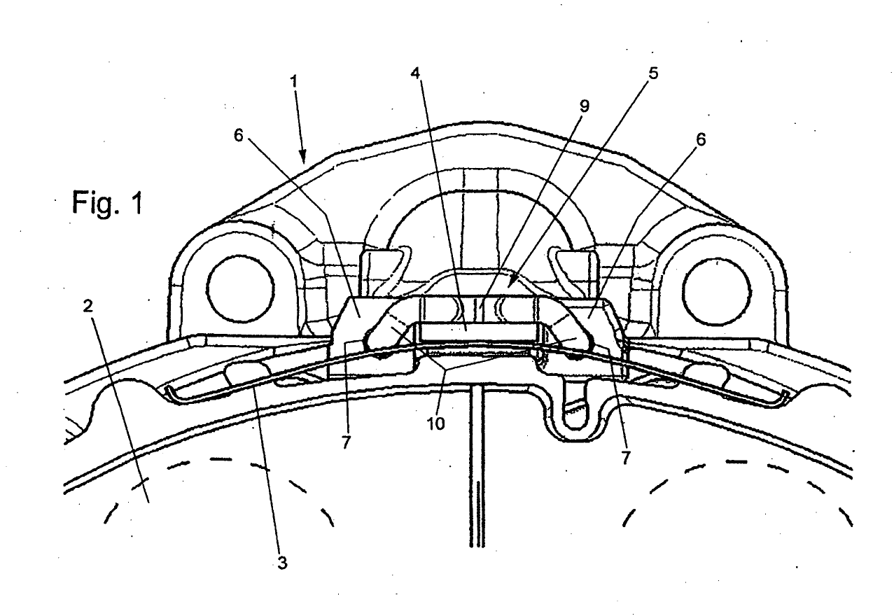

FIGS. 1, 2 and 5 illustrate a disk brake, in particular for a commercial vehicle, having a brake caliper 1, which has a receptacle space 15 for a brake application device (not shown). The brake caliper 1 straddles a brake disk 2′, which can be operatively connected to brake pads 2 and can be fastened to a brake carrier.

A retaining clip 4, on which springs 3 in the form of leaf springs which act on the outer edges of the brake pads 2 are supported, is detachably fastened to the brake caliper 1.

The retaining clip 4 is held in a positively engaging fashion at one end in a pocket-shaped receptacle 8 on the side of the caliper 1 which lies opposite the receptacle space 15, while the other end of the retaining clip 4 is connected to the caliper 1 by way of a fastening element 5.

This fastening element 5 has, according to the invention, two limbs 10, which extend at a distance from one another and which fit in position in a secured fashion in holes 7 provided next to the retaining clip 4 in the brake caliper 1.

In this context, the fastening element is embodied in the general shape of a W and has, in addition to the two limbs 10 which extend parallel to one another, a central bearing limb 9 which is supported on the retaining clip 4.

As is shown very clearly by FIG. 1, the limbs 10 extend underneath or below the bearing limb 9 and are plugged into the holes 7 located in bases 6 of the brake caliper 1. These bases 6 are expediently also integrally formed upon casting of the brake caliper 1. Moreover, the holes 7, and therefore the limbs 10, extend in the axial direction of the brake disk 2′.

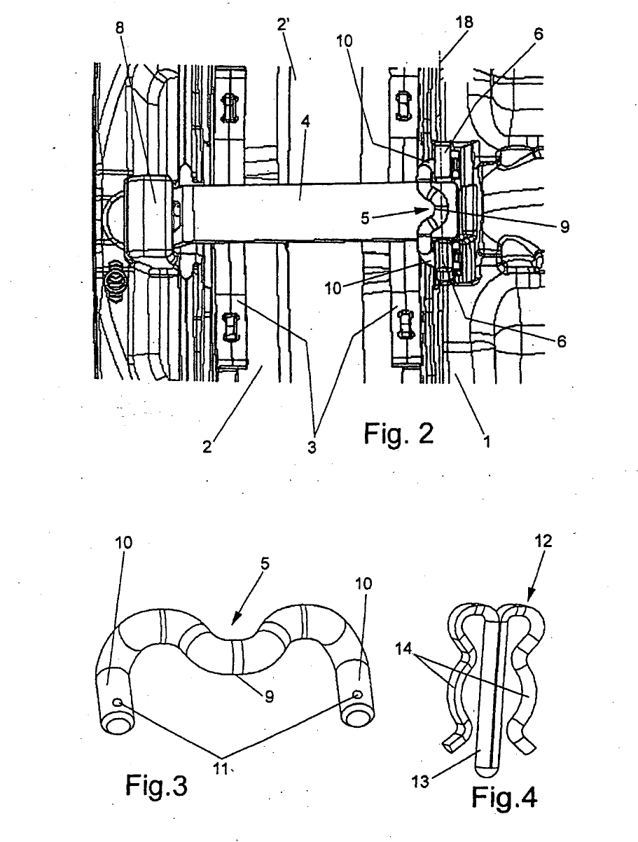

In the exemplary embodiment shown in FIG. 2, the limbs 10 of the fastening element 5 are plugged in on both sides through the bases 6. Each limb is secured at its end by use of a splint pin or a spring-type cotter pin 12, whose pin 13 is guided through a bore 11 of the assigned limb 10, while spring clamps 14, which adjoin the pin 13 on both sides, bear on the outside of the limb 10 (FIGS. 3 and 4).

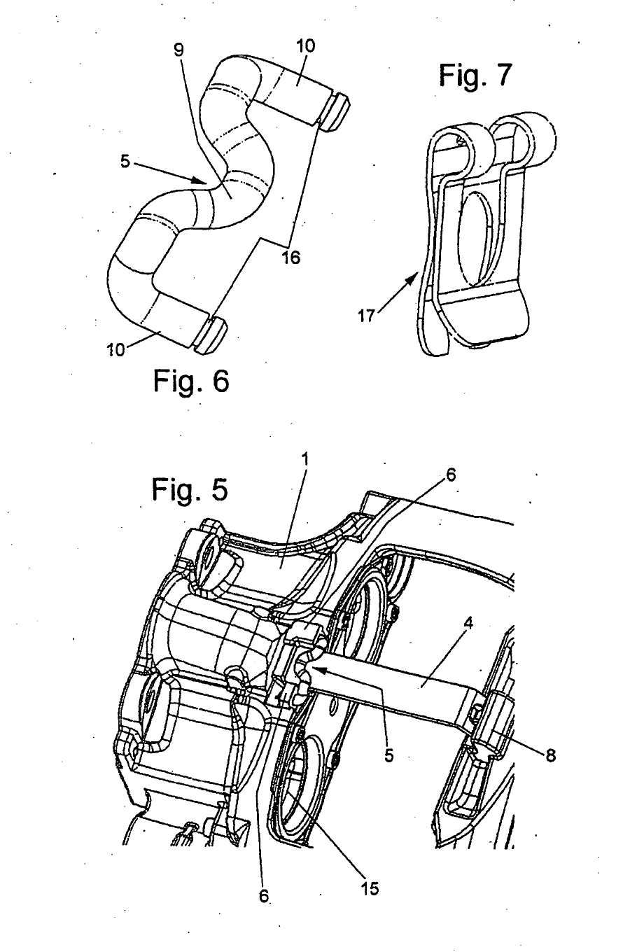

In the exemplary embodiment according to FIG. 5, a limb 10 of the fastening element 5 is guided through a base 6 and is axially secured there by use of a securing sheet-metal element 17, which is latched in a positively engaging fashion into a groove 16 of the limb 10.

The other limb 10 is longer and is plugged only into the assigned base 6, with the one-sided securement of the other limb 10 by way of the securing sheet-metal element 17 being sufficient by virtue of the limb 10 being guided over a longer distance.

In FIG. 2 it is apparent that the bearing limb 9 bears in a plane 18, transversely with respect to the center axis of the brake disk 2′, with the bases 6, which avoids a bending torque which would stress the bases 6. The bases 6 can, therefore, be manufactured using a small amount of material.

Standard parts can be used as securing elements in the form of the spring-type cotter pin 12 or of the securing sheet-metal element 17, and the selection in this context is not restricted to these two embodiments. Instead, other known securing elements can easily also be used.

Table of reference numerals

| | |
|---|---|
| 1 | Brake caliper |
| 2 | Brake shoe |
| 3 | Spring |
| 4 | Retaining clip |
| 5 | Fastening element |
| 6 | Base |
| 7 | Hole |
| 8 | Receptacle |
| 9 | Bearing limb |
| 10 | Limb |
| 11 | Bore |
| 12 | Spring-type cotter pin |
| 13 | Pin |
| 14 | Clamp |
| 15 | Receptacle space |
| 16 | Groove |
| 17 | Securing sheet-metal element |
| 18 | Plan |

1-13. (canceled)

14. A disc brake having a brake disc, comprising:
a caliper which straddles the brake disc, the caliper having a first section housing a brake application device;
brake pads selectively applied the brake disc via the brake application device;
a retaining clip detachably fastened to the caliper, the retaining clip supporting springs that act on outer edges of the brake pads;
a receptacle formed in the caliper, the receptacle bearing one end of the retaining clip in a positively locking manner, the other end of the retaining clip being retained on the caliper via a fastening element, the retaining clip being operatively arranged to span the brake disc when installed; and
wherein the fastening element comprises two limbs, extending at a distance from one another, the two limbs being secured in holes provided in the caliper on both sides next to the retaining clip.

15. The disc brake according to claim 14, wherein the fastening element is formed as a W-shaped clip.

16. The disc brake according to claim 14, wherein the limbs on the fastening element extend in parallel to one another.

17. The disc brake according to claim 15, wherein the limbs on the fastening element extend in parallel to one another.

18. The disc brake according to claim 14, wherein the two limbs extend in an axial direction of the brake disc.

19. The disc brake according to claim 16, wherein the two limbs extend in an axial direction of the brake disc.

20. The disc brake according to claim 14, wherein the fastening element comprises a bearing limb connecting the two limbs that extend at the distance from one another, the bearing limb bearing on the retainer clip.

21. The disc brake according to claim 18, wherein the fastening element comprises a bearing limb connecting the two limbs that extend at the distance from one another, the bearing limb bearing on the retainer clip.

22. The disc brake according to claim 19, wherein the fastening element comprises a bearing limb connecting the two limbs that extend at the distance from one another, the bearing limb bearing on the retainer clip.

23. The disc brake according to claim 20, wherein the two limbs are arranged below the bearing limb with respect to a center axis of the brake disc.

24. The disc brake according to claim 14, wherein each of the two limbs is mounted in a base of the caliper, said base being provided with the hole.

25. The disc brake according to claim 24, wherein the limbs penetrate the bases, each limb being provided with a securing element.

26. The disc brake according to claim 25, wherein the securing element is at least one of a split pin and a securing sheet-metal element.

27. The disc brake according to claim 24, wherein one of the two limbs is relatively longer and is guided in the hole in the base without any securing element, while the other of the two limbs penetrates its base and is secured via a securing element.

28. The disc brake according to claim 20, further comprising first and second bases formed in the caliper, each base including a hole for a respective limb; and
wherein the bearing limb and the first and second bases are arranged on a plane extending transversely with respect to a center longitudinal axis of the brake disc.

29. The disc brake according to claim 14, wherein the fastening element is retained on a side of the caliper having the first section housing the brake application device.

30. The disc brake according to claim 20, wherein the bearing limb bears against the retaining clip under compression.

31. The disc brake according to claim 14, wherein the disc brake is a commercial vehicle disc brake.

32. An apparatus for securing brake pads in a caliper of a disc brake, the apparatus comprising:
a retaining clip operatively configured to extend over a brake disc straddled by the caliper, wherein brake pads are arranged on each side of the brake disc within the caliper;
wherein the retaining clip bears against springs, each spring acting on lateral edges of one of the brake pads;
one end of the retaining clip being positively locked in a receptacle of the caliper, said receptacle being arranged on one side of the brake disc; and
another end of the retaining clip being retained on the caliper on the opposite side of the brake disc; and
a fastening element operatively configured to retain the retaining clip at its other end on the caliper, the fastening element comprising a clip having two substantially parallel limbs extending in an axial direction of the brake disc, the limbs being coupled at one end via a transversely extending bearing rim, which bears against the retaining clip, free ends of the substantially parallel limbs being positioned in respective holes formed in the caliper, one hole being respectively formed on each transverse side of the retaining clip.

33. The apparatus according to claim 32, wherein the clip has a W-shaped form, in which the limbs extend into associated axially arranged holes of the caliper; and
at least one securing element being provided for at least one of the limbs which penetrates through its associated hole in the caliper.
